(19) United States
(12) Patent Application Publication
(10) Pub. No.: US 2023/0359224 A1
(43) Pub. Date: Nov. 9, 2023

(54) MOVING BODY, INFORMATION PROCESSING METHOD, AND PROGRAM

(71) Applicant: Sony Group Corporation, Tokyo (JP)

(72) Inventors: Shota TAKAHASHI, Tokyo (JP); Shinsuke TAKUMA, Tokyo (JP); Tatsuya ISHIZUKA, Tokyo (JP)

(73) Assignee: Sony Group Corporation, Tokyo (JP)

(21) Appl. No.: 18/263,347

(22) PCT Filed: Jan. 20, 2022
(86) PCT No.: PCT/JP2022/001943

§ 371 Date: Jul. 28, 2023

(30) Foreign Application Priority Data
Feb. 22, 2021 (JP) 2021-025799

(51) Int. Cl. G05D 1/10; G05D 1/00; B64U 10/14

(52) U.S. Cl. CPC G05D 1/101; G05D 1/0088; B64U 10/14; B64U 2201/10; B64U 2201/20; B64U 2101/30

(57) ABSTRACT

A moving body (MB) includes a space recognition processor (VP) and an operation controller (FC). The space recognition processor (VP) generates odometry information (SPI) and map information (MI) of the moving body (MB). The operation controller (FC) generates position and orientation information (PI) of the moving body (MB) based on the odometry information (SPI). The operation controller (FC) causes the moving body (MB) to perform autonomous movement based on the position and orientation information (PI) at an abnormal time when an abnormality occurs in the moving body (MB). The operation controller (FC) controls the operation of the moving body (MB) according to a control instruction generated by an application processor (AP) based on the position and orientation information (PI) and the map information (MI) at a normal time when the moving body (MB) operates normally.

### FIELD

The present invention relates to a moving body, an information processing method, and a program.

### Background

In a case where an autonomous moving body such as a drone operates in a densely populated area or a wide region, safety and robustness of a control system are important. On the other hand, the moving body needs to process a large amount of information in real time, such as grasping a self-position and recognizing environment information.

### CITATION LIST

### Patent Literature

Patent Literature 1: JP 2019-179497 A

### SUMMARY

### Technical Problem

Although an increasing number of moving bodies autonomously move while performing a behavior plan based on information obtained from a space recognition processor, most of them are centralized architectures and thus face challenges in robustness and processing load.

Therefore, the present disclosure proposes a moving body, an information processing method, and a program that have high robustness and can distribute a processing load.

### Solution to Problem

According to the present disclosure, a moving body is provided that comprises: a space recognition processor configured to generate odometry information and map information of the moving body; and an operation controller configured to generate position and orientation information of the moving body based on the odometry information, cause the moving body to perform autonomous movement based on the position and orientation information at an abnormal time when an abnormality occurs in the moving body, and control an operation of the moving body according to a control instruction generated by an application processor based on the position and orientation information and the map information at a normal time when the moving body operates normally. According to the present disclosure, an information processing method in which an information process of the moving body is executed by a computer, and a program for causing the computer to execute the information process of the moving body, are provided.

### BRIEF DESCRIPTION OF DRAWINGS

FIG. 1 is a schematic diagram of a movement control system of a moving body.

FIG. 2 is a diagram illustrating behavior control of a conventional moving body.

FIG. 3 is a diagram illustrating behavior control of the moving body of the present disclosure.

FIG. 4 is a diagram illustrating an example in which an application processor is installed in an external server.

FIG. 5 is a diagram illustrating an example of a functional configuration of the moving body.

FIG. 6 is a diagram illustrating an example of a space recognition process by a space recognition processor.

FIG. 7 is a diagram illustrating an example of a map information generation process.

FIG. 8 is a diagram illustrating an example of a coordinate system that defines position and orientation information.

FIG. 9 is a diagram illustrating an example of an abnormality determination method.

FIG. 10 is a diagram illustrating an example of an abnormality response behavior.

FIG. 11 is a diagram illustrating attitude control of the moving body at an abnormal time.

FIG. 12 is a flowchart illustrating an example of information processing of the moving body.

FIG. 13 is a diagram illustrating a hardware configuration example of a control unit.

### DESCRIPTION OF EMBODIMENTS

Hereinafter, embodiments of the present disclosure will be described with reference to the drawings. In each of the following embodiments, same parts are given the same reference signs to omit redundant description.

Note that the description will be given in the following order.
[1. Overview]
[1-1. System configuration example]
[1-2. Outline of behavior control of moving body]
[2. Functional configuration of moving body]
[3. Space recognition process]
[4. Abnormality determination]
[5. Abnormality response behavior]
[6. Information processing method]
[7. Hardware configuration example]
[8. Effects]

### 1. Overview

### 1-1. System Configuration Example

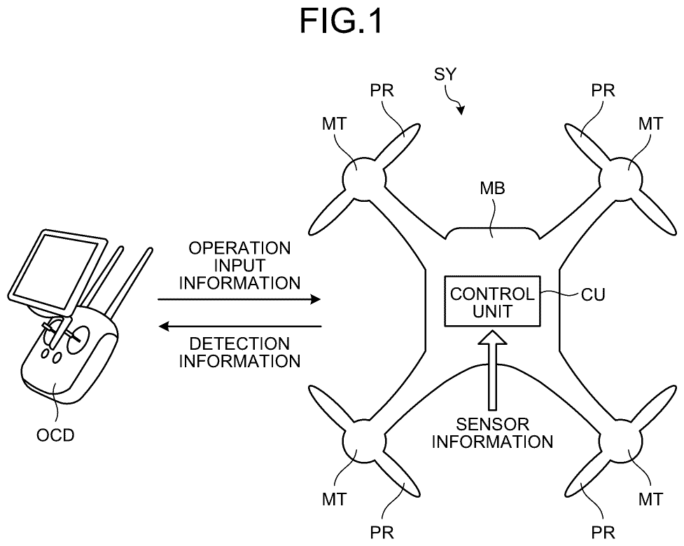

FIG. 1 is a schematic diagram of a movement control system SY of a moving body MB.

The moving body MB is an autonomous mobile device that is movable by automatic control. In the following description, an example in which the moving body MB is a drone will be described, but the moving body MB is not limited to the drone. An information processing method of the present disclosure can also be applied to an automobile or the like that can be automatically controlled.

The movement control system SY includes the moving body MB and an external controller OCD for remote control. The external controller OCD remotely controls a destination, a moving direction, a moving speed, and the like of the moving body MB. The moving body MB recognizes a surrounding space (outside world) based on sensor information, and generates a route plan to the destination. A space recognition process is performed using a simultaneous localization and mapping (SLAM) technology.

The moving body MB sets a control target CT of the moving body MB based on the route plan. The control target CT is a target value (target speed) of an operation speed such as movement and rotation of the moving body MB. In an example in FIG. 1, a target rotation speed of four propellers PR is controlled based on the control target CT. By appropriately setting the control target CT, operations such as ascent, descent, hovering, horizontal movement, and turning are performed. Setting of the control target CT and drive control of a motor MT based on the control target CT are performed by a control unit CU inside the moving body MB.

When an abnormality occurs in the moving body MB, the operation of the moving body MB becomes unstable. In the present disclosure, when an abnormality occurs in the moving body MB, an abnormality response behavior for ensuring safety of the moving body MB is performed. There are various causes of the abnormality of the moving body MB, and one of them is an abnormality of an application processor. As described below, the control unit CU includes a space recognition processor, an application processor, and an operation controller. The application processor is a main processor that creates a behavior plan of the moving body MB. Hereinafter, an example in which an abnormality of the moving body MB occurs due to an abnormality of the application processor will be described.

### 1-2. Outline of Behavior Control of Moving Body

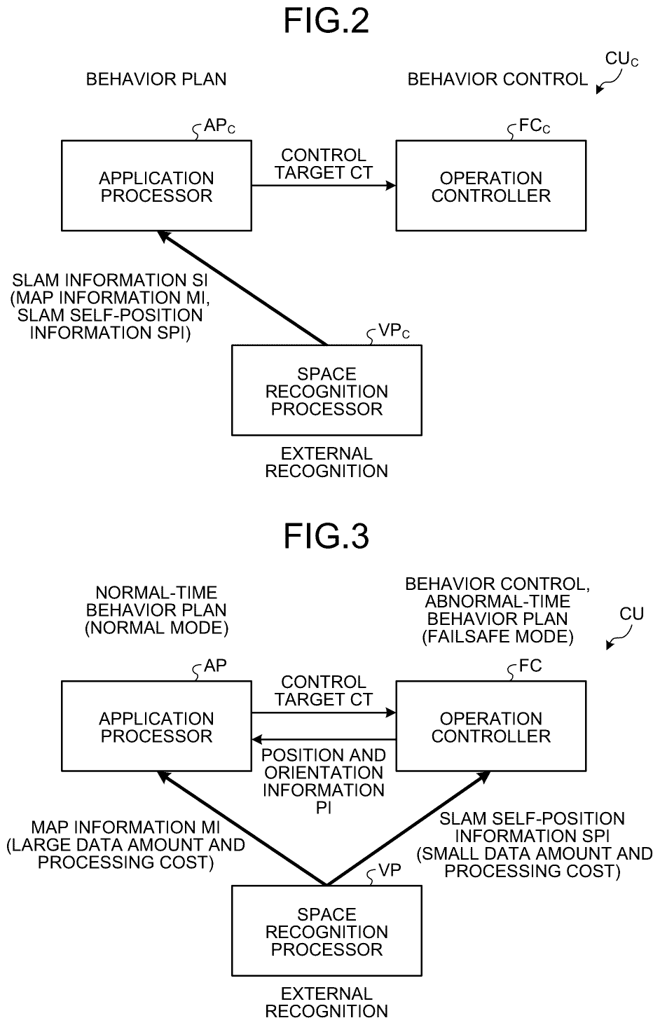

FIG. 2 is a diagram illustrating behavior control of a conventional moving body MB. FIG. 3 is a diagram illustrating behavior control of the moving body MB of the present disclosure.

As illustrated in FIG. 2, in a conventional control unit CU, a space recognition processor VP_{c}, an application processor AP_{c}, and an operation controller FC_{c} are connected in series. The space recognition processor VP_{c} is a processor that recognizes an outside world using the SLAM technology. The space recognition processor VP_{c} generates SLAM information SI based on the sensor information. The SLAM information SI includes map information MI indicating information on a surrounding environment and SLAM self-position information SPI which is odometry information on the position and the attitude of the moving body MB.

The SLAM information SI is supplied to the application processor AP_{c}. The application processor AP_{c} generates a behavior plan of the moving body MB including the route plan based on the SLAM information SI. The application processor AP_{c} sets the control target CT of the moving body MB based on the behavior plan and supplies the control target CT to the operation controller FC_{c}. The operation controller FC_{c} controls driving of the motor MT (operation of the moving body MB) based on the control target CT.

In the configuration in FIG. 2, when an abnormality occurs in the application processor AP_{c}, the control target CT is not supplied to the operation controller FC_{c}. Therefore, the control of the moving body MB may be interfered. The application processor AP_{c} is required to perform various processes such as space recognition and obstacle detection, but in the configuration in FIG. 2, redundancy safety is not sufficient against increasing requests for information processing. Therefore, the abnormality of the application processor AP_{c} may directly lead to a risk such as a failure.

In order to solve the above-described disadvantage, the present disclosure adopts a system in which the operation controller FC can control the motor MT based on the SLAM self-position information SPI even when an abnormality occurs in the application processor AP.

As illustrated in FIG. 3, in the present disclosure, an application processor AP and an operation controller FC are connected in parallel to a space recognition processor VP. The SLAM information SI generated by a space recognition processor CVP is distributed and supplied to the application processor AP and the operation controller FC. For example, the map information MI with a large processing load is selectively supplied to the application processor AP. The SLAM self-position information SPI having a relatively small processing load is selectively supplied to the operation controller FC.

The operation controller FC has two operation modes (normal mode and failsafe mode) according to the operation state of the application processor AP. The normal mode is an operation mode at a normal time when the application processor AP operates normally. The failsafe mode is an operation mode at an abnormal time when an abnormality occurs in the application processor AP. In the normal mode, the operation controller FC performs behavior control of the moving body MB according to a control instruction of the application processor AP. In the failsafe mode, the operation controller FC generates an abnormal-time behavior plan of the moving body MB by itself based on the SLAM self-position information SPI, and performs the behavior control of the moving body MB based on the abnormal-time behavior plan generated.

For example, the operation controller FC generates position and orientation information PI of the moving body MB with high accuracy by fusing the SLAM self-position information SPI with sensor information such as GPS information. The operation controller FC supplies the position and orientation information PI generated to the application processor AP.

The application processor AP generates a behavior plan using the map information MI acquired from the space recognition processor VP and the position and orientation information PI acquired from the operation controller FC. The application processor AP generates a control target CT (first control target) of the moving body MB based on the behavior plan. In the normal mode, the operation controller FC controls the operation (motor MT) of the moving body MB based on the control target CT generated by the application processor AP.

When an abnormality occurs in the application processor AP, the operation controller FC shifts from the normal mode to the failsafe mode. In the failsafe mode, the operation controller FC generates the abnormal-time behavior plan based on the position and orientation information PI of the moving body MB generated by the operation controller FC itself. The abnormal-time behavior plan is a behavior plan according to a preset abnormality response behavior. The abnormality response behavior is an autonomous operation performed by the moving body MB at the abnormal time to ensure safety of the moving body MB. The operation controller FC generates a control target CT (second control target) of the moving body MB based on the abnormal-time behavior plan. The operation controller FC controls the operation of the moving body MB based on the control target CT generated by the operation controller FC itself.

FIG. 3 illustrates an example in which the space recognition processor VP, the application processor AP, and the operation controller FC are all mounted on the moving body MB, but the configuration of the moving body MB is not limited thereto.

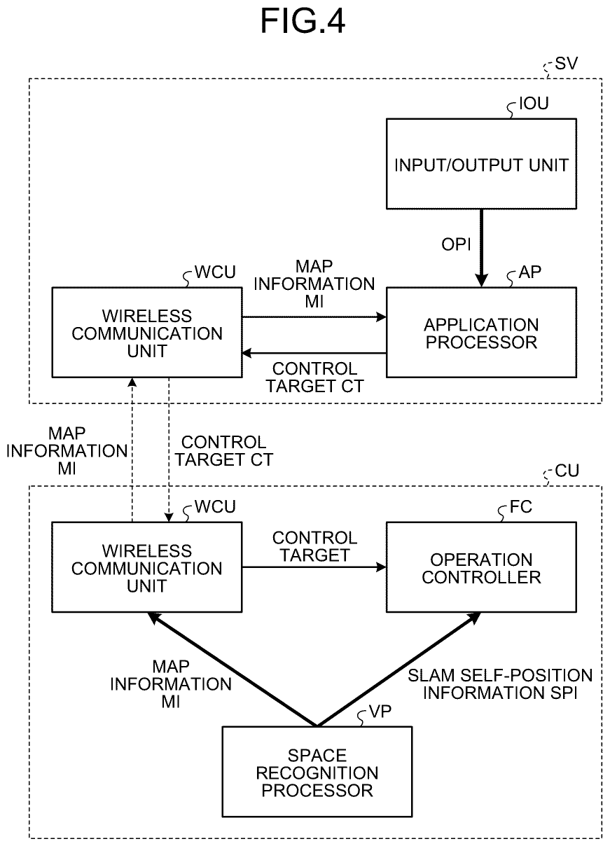

For example, FIG. 4 is a diagram illustrating an example in which the application processor AP is installed in an external server SV. The control unit CU and the server SV each includes a wireless communication unit WCU that performs wireless communication. As the communication standard, a wireless local area network (LAN) such as Wi-Fi (registered trademark), a fifth generation mobile communication system (5G), and the like are used.

The control unit CU includes the wireless communication unit WCU that performs wireless communication with the application processor AP mounted on the server SV. The map information MI generated by the space recognition processor VP is supplied to the application processor AP via wireless communication. The control target CT generated by the application processor AP is supplied to the operation controller FC via wireless communication. The server SV includes, for example, an input/output unit IOU that supplies operation information OPI such as a destination to the application processor AP. In the example in FIG. 4, the application processor AP is installed in the external server SV. Therefore, a small moving body MB capable of performing rich processes is provided.

### 2. Functional Configuration of Moving Body

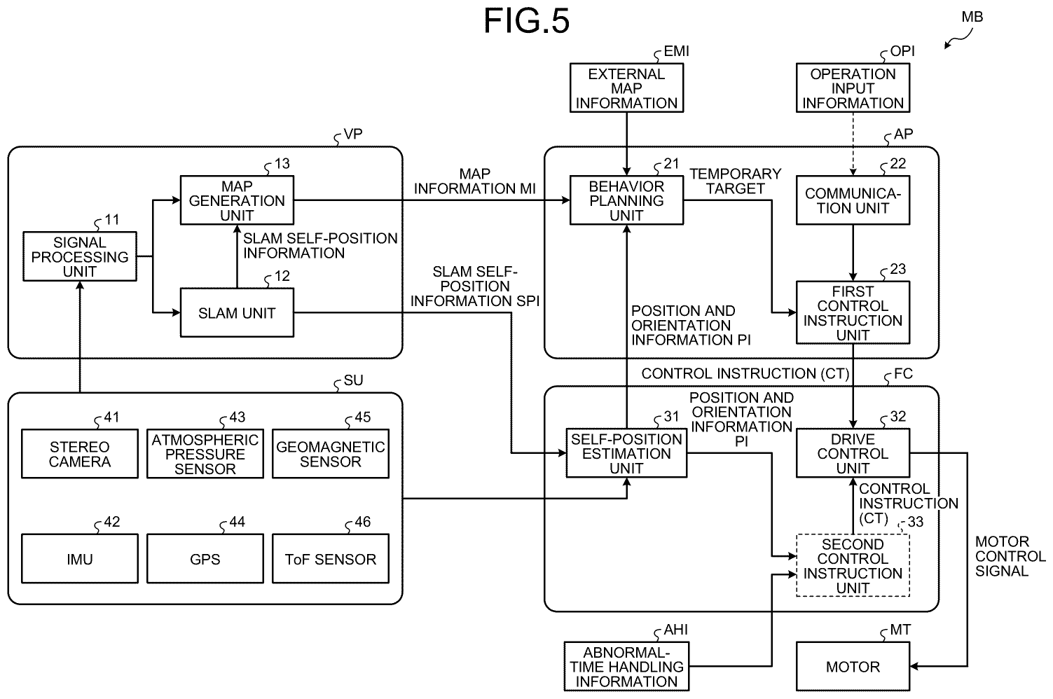

FIG. 5 is a diagram illustrating an example of a functional configuration of the moving body MB.

The space recognition processor VP includes a signal processing unit (DSP) 11, a SLAM unit 12, and a map generation unit 13.

The signal processing unit 11 performs signal processing on the sensor information detected by the sensor unit SU and outputs the sensor information to the SLAM unit 12 and the map generation unit 13. The sensor unit SU includes a plurality of sensors for performing SLAM. Examples of the plurality of sensors include a stereo camera 41, an inertial measurement unit (IMU) 42, an atmospheric pressure sensor 43, a global positioning system (GPS) 44, a geomagnetic sensor 45, and a time of flight (ToF) sensor 46.

In the present disclosure, visual SLAM is used as a SLAM technique used for the space recognition process, but the SLAM technique is not limited thereto. For example, the space recognition process may be performed using a LiDAR SLAM technique. Furthermore, in the present disclosure, the stereo camera 41 is exemplified as a camera used in SLAM, but the camera is not limited thereto. For example, a monocular camera, a fisheye camera, an RGB-D camera, a ToF camera, or the like may be used as a camera for recognizing the outside world. Furthermore, the configuration of the sensor unit SU described above is an example, and the types of sensors included in the sensor unit SU are not limited to those described above.

### 3. Space Recognition Process

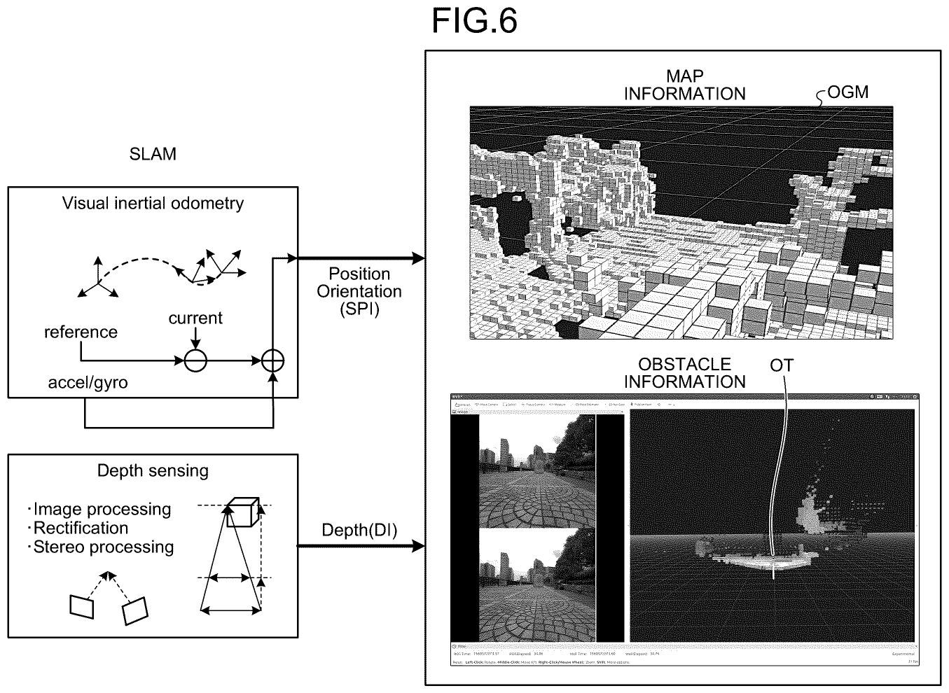

FIG. 6 is a diagram illustrating an example of a space recognition process by the space recognition processor VP.

For example, the signal processing unit 11 generates depth information DI of a surrounding space based on a stereo image captured by the stereo camera 41. The signal processing unit 11 generates acceleration information regarding a direction and a magnitude of acceleration for each time based on IMU data measured by the IMU 42. The signal processing unit 11 outputs the acceleration information to the SLAM unit 12 and outputs the depth information DI to the map generation unit 13.

The SLAM unit 12 generates the SLAM self-position information SPI based on the acceleration information. The SLAM self-position information SPI is information indicating a position (x, y, z), a speed (vx, vy, vz), and an attitude (roll, pitch, yaw) of the moving body MB for each time. The position, the speed, and the attitude are expressed in a local coordinate system with a start position of the moving body MB as an origin. As the local coordinate system, for example, an FRD coordinate system is used. The FRD coordinate system is a three-dimensional coordinate system in which forward, right, and down of the moving body MB are set as positive directions. The attitude is actually represented by quaternion.

The SLAM unit 12 generates the SLAM self-position information SPI by fusing the depth information DI into the acceleration information (visual inertial odometry). The SLAM unit 12 outputs the SLAM self-position information SPI to the operation controller FC. Since the SLAM self-position information SPI is the odometry information, an error accumulates in the SLAM self-position information SPI with a movement distance and time. Therefore, the operation controller FC fuses other sensor information to the SLAM self-position information SPI to generate the position and orientation information PI of the moving body MB with high accuracy and high robustness.

The map generation unit 13 generates the map information MI based on the depth information DI. The map information MI includes map information indicating environment map OGM and obstacle information indicating presence or absence and a position of an obstacle OT. The environment map OGM is a map describing information on the surrounding environment. In the present embodiment, for example, an occupied grid map is used as the environment map OGM. The occupied grid map is a type of metering map that stores distances and directions between points. In the occupied grid map, the environment is divided into a plurality of grids, and a presence probability of an object is stored for each grid.

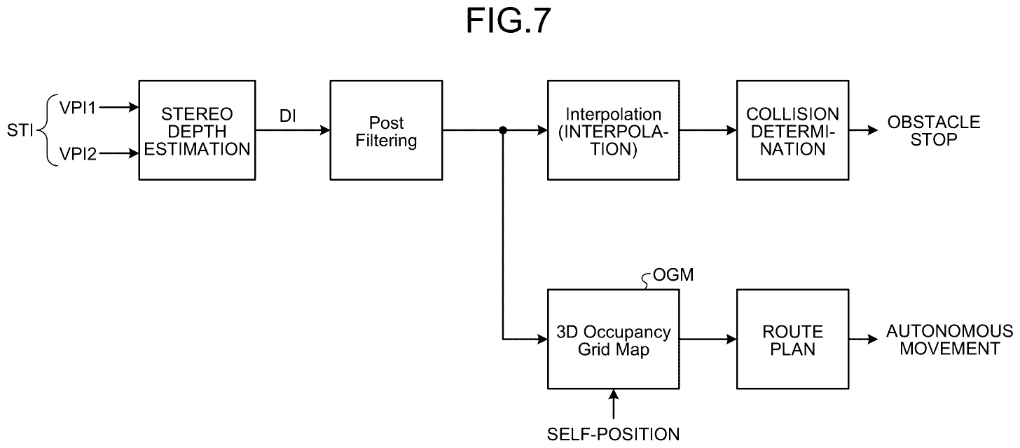

FIG. 7 is a diagram illustrating an example a generation process of the map information MI.

The map generation unit 13 extracts feature points corresponding to each other (corresponding points) from a first viewpoint image VPI1 and a second viewpoint image VPI2 included in the stereo image STI of the stereo camera 41. The map generation unit 13 calculates the depth of the feature point by a method such as triangulation based on parallax between the corresponding points. The map generation unit 13 extracts the depth information DI of only a highly reliable image area except for the image area having an unnatural step in depth (depth estimation).

The map generation unit 13 performs noise removal from the depth information DI using a filter such as post filtering. The map generation unit 13 interpolates a region from which the noise has been removed based on the depth information DI obtained by the post-filtering, and generates 3D data of a subject (Interpokation). The 3D data of the subject is used for collision determination between the moving body MB and the subject, and enables the moving body MB to stop in front of an obstacle.

The map generation unit 13 generates the environment map OGM around the moving body MB based on the depth information DI obtained by the post-filtering. By adding the position information of the moving body MB to the environment map OGM, the position of the moving body MB in the environment map OGM is obtained. The route plan to the destination is generated based on the position of the moving body MB in the environment map OGM, and autonomous movement can be performed according to the route plan.

Returning to FIG. 5, the application processor AP includes a behavior planning unit 21, a communication unit 22, and a first control instruction unit 23.

The behavior planning unit 21 acquires the position and orientation information PI from the operation controller FC. The behavior planning unit 21 generates a behavior plan of the moving body MB based on the position and orientation information PI, the map information MI, and external map information EMI. The external map information EMI includes topographical information generated by using external map information such as base map information of the Geospatial Information Authority of Japan, and information such as a flight prohibited area and a geofence. The behavior planning unit 21 generates a behavior plan while supplementing distant terrain information that cannot be detected as the map information MI by the external map information EMI. The behavior plan includes a route plan for avoiding the obstacle OT and arriving at the destination.

The behavior planning unit 21 generates a temporary target TT based on the behavior plan. The temporary target TT is a temporary target value (target speed) of an operation speed such as movement or rotation of the moving body MB. The behavior planning unit 21 sets the temporary target TT of the moving body MB at regular time intervals so that the moving body MB can act according to the behavior plan, and outputs the temporary target TT to the first control instruction unit 23.

The communication unit 22 performs wireless communication with the external controller OCD. The communication unit 22 outputs operation input information OPI acquired from the external controller OCD to the first control instruction unit 23. The operation input information OPI includes information for remotely operating the moving body MB. The operation input information OPI includes, for example, information such as a destination, a moving direction, and a moving speed of the moving body MB.

The first control instruction unit 23 generates the control target CT of the moving body MB at regular time intervals based on the temporary target TT and the operation input information OPI, and outputs the control target CT to the operation controller FC. The control target CT is a final target value (target speed) of the operation speed of the moving body MB output as a control instruction to the operation controller FC. The control target CT is obtained by correcting the temporary target TT with the operation input information OPI. Therefore, the control target CT becomes a control target (first control target) of the moving body MB conforming to the behavior plan. The control target CT is, for example, a target speed (vx_sp, vy_sp, vz_sp, yaw_rate_sp) in a front-back direction, a left-right direction, a top-bottom direction, and a turning direction of the moving body MB. The control target CT is represented by a local coordinate system (FRD coordinate system).

The operation controller FC includes a self-position estimation unit 31, a drive control unit 32, and a second control instruction unit 33.

The self-position estimation unit 31 generates the position and orientation information PI of the moving body MB based on the SLAM self-position information SPI. The position and orientation information PI is highly accurate and highly robust position and orientation information obtained by fusing the sensor information detected by the sensor unit SU to the SLAM self-position information SPI. For example, the self-position estimation unit 31 generates the position and orientation information PI of the moving body MB by fusing the atmospheric pressure information acquired by the atmospheric pressure sensor 43, the GPS information acquired by the GPS 44, the geomagnetic information acquired by the geomagnetic sensor 45, and the distance information acquired by the ToF sensor 46 to the SLAM self-position information SPI. The self-position estimation unit 31 outputs the position and orientation information PI to the behavior planning unit 21 and the second control instruction unit 33.

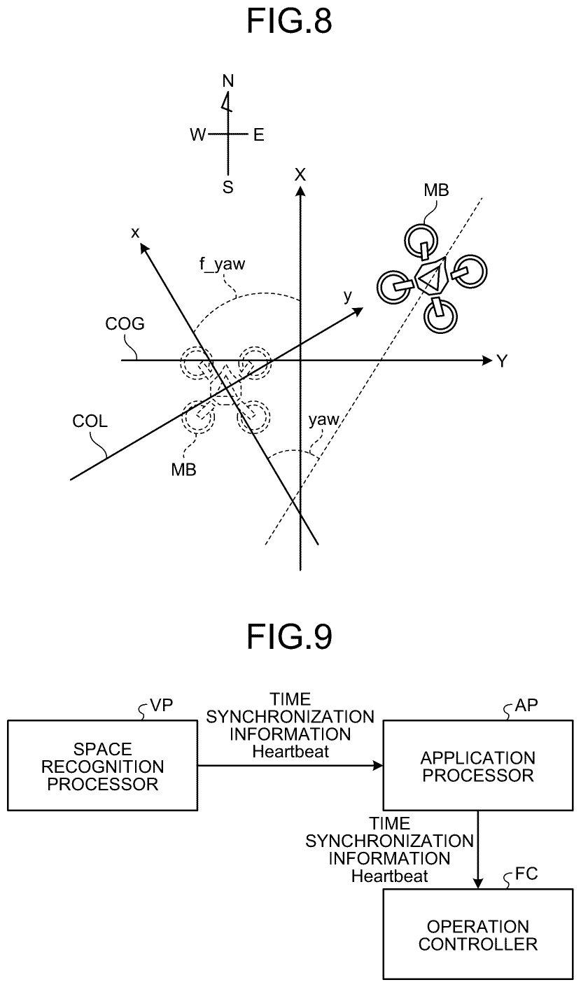

FIG. 8 is a diagram illustrating an example of a coordinate system that defines the position and orientation information PI.

The position and orientation information PI includes, for example, a local position represented by a local coordinate system COL and a global position represented by a global coordinate system COG. The local coordinate system COL is, for example, an FRD coordinate system with a start position of the moving body MB as an origin. The local position includes information on the position (x, y, z), the speed (vx, vy, vz), and the attitude (roll, pitch, yaw). Since the local position is obtained without the GPS information, the local position is available both indoors (GPS 44 disabled) and outdoors (GPS 44 enabled). Although an error is accumulated in the position information, continuity of the position information is maintained from the start of the moving body MB.

The global coordinate system is, for example, an NED coordinate system used by the GPS 44 in which North, East, and down are positive directions. The global position includes information on the position (latitude, longitude, altitude), the speed (vX, vY, vZ), and a heading. The global position is available outdoors (GPS 44 is enabled) because the GPS information is required. As long as the GPS 44 is enabled, the accuracy of the position information is high, but the reliability may vary depending on the environment.

Note that the yaw direction of the local coordinate system is determined for each start of the moving body MB. Therefore, a rotation amount of the local coordinate system from the global coordinate system is managed as f_yaw. The self-position estimation unit 31 converts the global position into the local position using the information of f_yaw, and corrects the position of the local position.

Returning to FIG. 5, when an abnormality occurs in the application processor AP, the second control instruction unit 33 generates a behavior plan at the abnormal time (abnormal-time behavior plan) based on the abnormal-time handling information AHI. In the abnormal-time handling information AHI, an abnormality response behavior is defined. The abnormality response behavior includes, for example, a behavior of autonomously moving to a preset evacuation position (e.g., start position of the moving body MB). The abnormal-time behavior plan includes a route plan for reaching the evacuation position.

The second control instruction unit 33 generates the control target CT (second control target) of the moving body MB conforming to the abnormal-time behavior plan based on the position and orientation information PI and the abnormal-time behavior plan. Since the control target CT is set in consideration of the position and orientation information PI of the moving body MB, the operation of the moving body MB is stabilized. The second control instruction unit 33 generates the control target CT of the moving body MB at regular time intervals so that the moving body MB can act according to the abnormal-time behavior plan, and outputs the control target CT to the drive control unit 32.

The drive control unit 32 sets the rotation speed of each motor MT based on the control target CT. The drive control unit 32 generates a motor control signal based on the set rotation speed for each motor MT, and drives the motor MT. At the normal time when the application processor AP operates normally, the drive control unit 32 drives the motor MT based on the control target CT acquired from the first control instruction unit 23. At an abnormal time when an abnormality occurs in the application processor AP, the drive control unit 32 cannot acquire the control target CT from the first control instruction unit 23, and thus drives the motor MT based on the control target CT acquired from the second control instruction unit 33.

As a result, at the abnormal time, the operation controller FC causes the moving body MB to perform autonomous movement defined as the abnormality response behavior based on the position and orientation information PI. At the normal time, the operation controller FC controls the operation of the moving body MB according to the control instruction generated by the application processor AP based on the position and orientation information PI and the map information MI.

### 4. Abnormality Determination

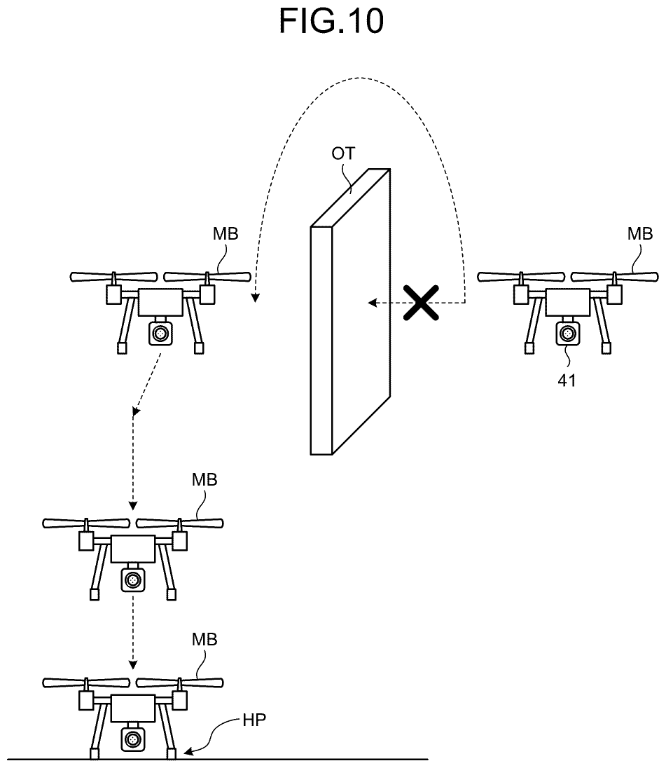

FIG. 9 is a diagram illustrating an example of an abnormality determination method.

The space recognition processor VP periodically transmits time synchronization information and a HeartBeat to the application processor AP at regular time intervals. The application processor AP periodically transmits the time synchronization information and the HeartBeat to the operation controller FC at regular time intervals. A transmission cycle of the time synchronization information and the HeartBeat is, for example, 1 Hz, but the transmission cycle is not limited thereto.

The time synchronization information is correction information for synchronizing the times of the space recognition processor VP, the application processor AP, and the operation controller FC. The space recognition processor VP, the application processor AP, and the operation controller FC each have an independent time stamp. The time synchronization information indicates an offset (deviation) between the time stamps. When the time synchronization information is received on a reception side, the time on the reception side is synchronized with the time on a transmission side based on the time synchronization information. When the time synchronization information is not received by the reception side, the time on the reception side is determined based on internal clock information (time stamp) corrected based on the latest time synchronization information.

The HeartBeat is a vital monitoring signal for notifying the normal operation of the transmission side. The reception side (monitoring side) always checks whether or not the HeartBeat is coming without interruption. When the reception of the HeartBeat is stopped for a certain period of time, the reception side determines that a failure has occurred on the transmission side (non-monitoring side). When the reception of the HeartBeat from the application processor AP is interrupted for a certain period of time, the operation controller FC determines that an abnormality has occurred in the application processor AP. When it is determined that an abnormality has occurred in the application processor AP, the operation controller FC generates an abnormal-time behavior plan of the moving body MB based on the position and orientation information PI generated by the operation controller FC itself, and causes the moving body MB to autonomously move based on the position and orientation information PI.

### 5. Abnormality Response Behavior

FIG. 10 is a diagram illustrating an example of the abnormality response behavior.

FIG. 10 illustrates an example in which the moving body MB returns to a home position HP (return to home) as the abnormality response behavior. For example, as the autonomous operation at the abnormal time, the operation controller FC causes the moving body MB to perform hovering for a predetermined period from the occurrence of the abnormality. When the abnormality continues after the predetermined period, the operation controller FC causes the moving body MB to perform a return-to-home operation.

The home position HP is set, for example, as a position where the moving body MB starts moving (start position). The home position HP is extracted from the SLAM self-position information SPI. At the abnormal time, since the map information MI (map information and obstacle information) is not available, the operation controller FC generates a route plan, for example, for linearly moving from a current position to the home position HP. At this time, the operation controller FC can start the movement (e.g., return-to-home movement) in a horizontal direction after elevating the moving body MB to a preset altitude so as to make it difficult to collide with the obstacle OT.

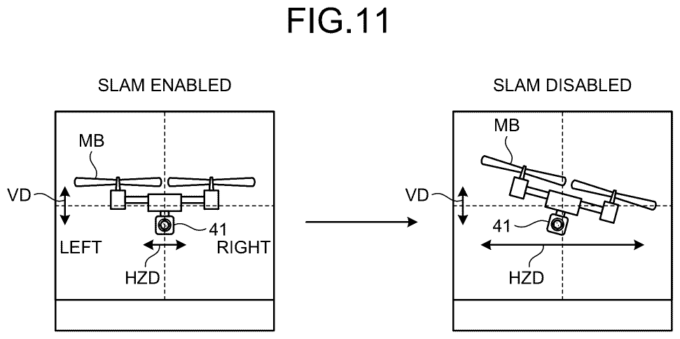

FIG. 11 is a diagram illustrating attitude control of the moving body MB at the abnormal time.

As illustrated on the left side of FIG. 11, at the abnormal time, the operation controller FC controls the attitude of the moving body MB based on the position and orientation information PI of the moving body MB generated by the operation controller FC itself. Since the position information of the moving body MB is also available, landing control or the like in consideration of a safe speed or the like is also possible.

As described above, in the conventional control illustrated in FIG. 2, all the SLAM information SI generated by the space recognition processor VP is supplied to the application processor AP. The position and orientation information PI is generated by the application processor AP, and only the control instruction generated by the application processor AP is supplied to the operation controller FC. Since the SLAM self-position information SPI is not supplied to the operation controller FC, when an abnormality occurs in the application processor AP, the attitude control by SLAM is disabled. Therefore, as illustrated on the right side of FIG. 11, at the abnormal time, the moving body MB cannot maintain a stable attitude in a horizontal direction HZD and a vertical direction VD.

In the present disclosure, the SLAM information SI is divided and supplied to the application processor AP and the operation controller FC. Since the SLAM self-position information SPI is supplied to the operation controller FC, the attitude control by the SLAM is enabled even when the abnormality occurs in the application processor AP. Therefore, as illustrated on the left side of FIG. 11, the moving body MB can maintain a stable attitude in the horizontal direction HZD and the vertical direction VD even at the abnormal time.

### 6. Information Processing Method

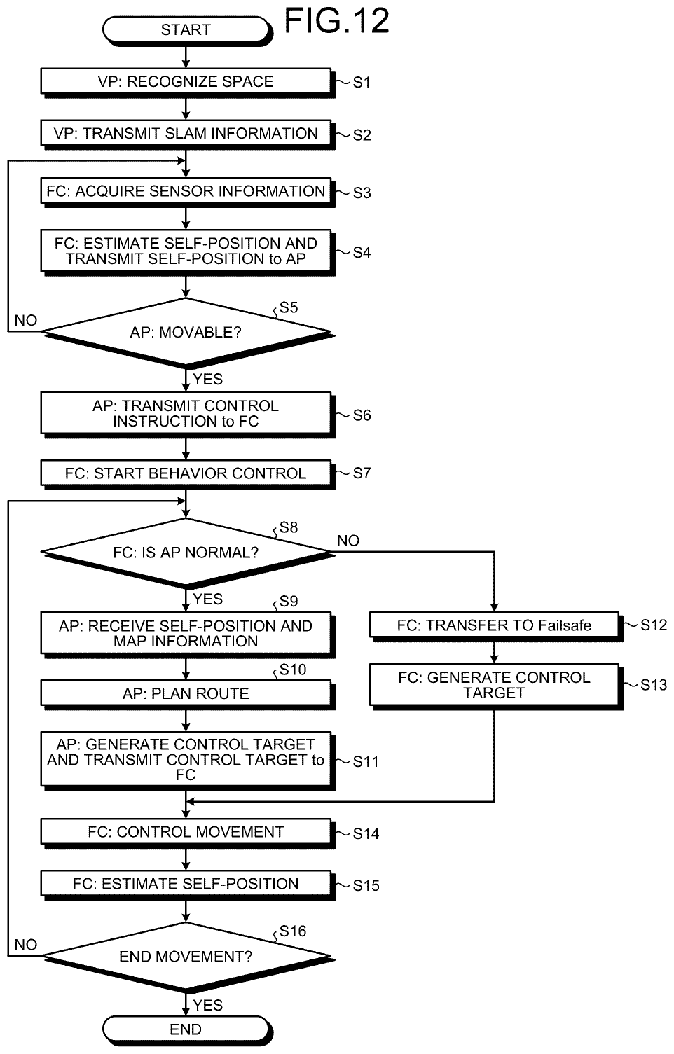

FIG. 12 is a flowchart illustrating an example of information processing of the moving body MB.

In Step S1, the space recognition processor VP generates the SLAM information SI by the space recognition process. In Step S2, the space recognition processor VP supplies the SLAM information SI to the application processor AP and the operation controller FC in a divided manner. Among the SLAM information SI, the map information MI is supplied to the application processor AP, and the SLAM self-position information SPI is supplied to the operation controller FC.

In Step S3, the operation controller FC acquires the sensor information for performing sensor fusion from the sensor unit SU. The sensor information includes, for example, information obtained from measurement data of the IMU 42, the atmospheric pressure sensor 43, the GPS 44, the geomagnetic sensor 45, and the ToF sensor 46.

In Step S4, the operation controller FC generates the position and orientation information PI of the moving body MB based on the SLAM self-position information SPI acquired from the space recognition processor VP and the sensor information acquired for sensor fusion. The operation controller FC supplies the position and orientation information PI generated to the application processor AP.

In Step S5, the application processor AP determines whether or not the moving body MB is movable. The application processor AP determines that movement is possible when information necessary for starting the movement is acquired, such as in a case where appropriate map information MI and position and orientation information PI are acquired, and determines that movement is impossible when the necessary information is not acquired. When it is determined in Step S5 that the movement is impossible (Step S5: No), the process returns to Step S3, and the above-described processes are repeated until it is determined that the movement is possible.

When it is determined in Step S5 that the movement is possible (Step S5: Yes), the process proceeds to Step S6. In Step S6, the application processor AP generates the control target CT of the moving body MB based on the map information MI, the position and orientation information PI, and the operation input information OPI. The application processor AP causes the operation controller FC to control the moving body MB based on the control target CT. In Step S7, the operation controller FC performs behavior control of the moving body MB based on the control instruction of the application processor AP.

In Step S8, the operation controller FC determines whether or not the application processor AP is operating normally. For example, when the HeartBeat can be received from the application processor AP, the operation controller FC determines that the application processor AP is operating normally. The operation controller FC determines that an abnormality has occurred when a state in which no HeartBeat can be received from the application processor AP continues for a certain period of time or more.

When it is determined in Step S8 that the operation of the application processor AP is normal (Step S8: Yes), the process proceeds to Step S9. In Step S9, the application processor AP acquires the map information MI from the space recognition processor VP, and acquires the position and orientation information PI from the operation controller FC.

In Step S10, the application processor AP generates a route plan to the destination based on the map information MI, the position and orientation information PI, and the operation input information OPI. In Step S11, the application processor AP generates the control target CT based on the route plan. The application processor AP causes the operation controller FC to control the moving body MB based on the control target CT. Thereafter, the process proceeds to Step S14.

When it is determined in Step S8 that an abnormality has occurred in the application processor AP (Step S8: No), the process proceeds to Step S12. In Step S12, the operation controller FC shifts to the failsafe mode. In Step S13, the operation controller FC generates an abnormal-time behavior plan based on the position and orientation information PI generated by the operation controller FC itself. The operation controller FC generates the control target CT based on the abnormal-time behavior plan. Thereafter, the process proceeds to Step S14.

In Step S14, the operation controller FC performs the behavior control of the moving body MB based on the control target CT. At the normal time when the application processor AP operates normally, the behavior control is performed based on the control target CT generated by the application processor AP (normal mode). When an abnormality occurs in the application processor AP, the behavior control is performed based on the control target CT generated by the operation controller FC (failsafe mode).

In Step S15, the operation controller FC estimates the position of the moving body MB based on the position and orientation information PI. In Step S16, the operation controller FC determines whether or not to end the movement. For example, the operation controller FC determines to end the movement when the moving body MB reaches the destination (e.g., home position HP) set in the abnormal-time behavior plan. When the moving body MB has not reached the destination, the operation controller FC determines not to end the movement.

When it is determined in Step S16 that the movement is to be ended (Step S16: Yes), the operation controller FC ends the behavior control of the moving body MB. When it is determined in Step S16 that the movement is not to be ended (Step S16: Yes), the process returns to Step S8, and the above-described processes are repeated until the moving body MB reaches the destination.

### 7. Hardware Configuration Example

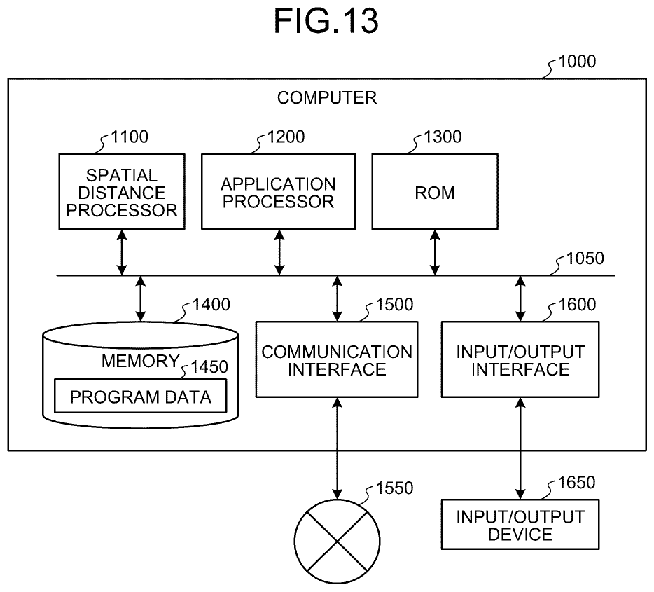

FIG. 13 is a diagram illustrating a hardware configuration example of the control unit CU.

The control unit CU is, for example, implemented by a computer 1000 having a configuration as illustrated in FIG. 13. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program stored in the ROM 1300 or the HDD 1400, and controls each unit. For example, the CPU 1100 develops a program stored in the ROM 1300 or the HDD 1400 into the RAM 1200, and executes processes corresponding to various programs.

The ROM 1300 stores a boot program such as a basic input output system (BIOS) executed by the CPU 1100 when the computer 1000 is activated, a program dependent on hardware of the computer 1000, and the like.

The HDD 1400 is a computer-readable non-transitory recording medium that non-transiently records a program executed by the CPU 1100, data used by the program, and the like. Specifically, the HDD 1400 is a recording medium that records the information processing program according to the present disclosure, which is an example of program data 1450.

The communication interface 1500 is an interface for the computer 1000 to connect to an external network 1550 (e.g., the Internet). For example, the CPU 1100 receives data from another apparatus or transmits data generated by the CPU 1100 to another apparatus via the communication interface 1500.

The input/output interface 1600 is an interface for connecting an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the control unit CU, the CPU 1100 of the computer 1000 implements the functions of the control unit CU by executing an information processing program loaded on the RAM 1200. In addition, the HDD 1400 stores the information processing program according to the present disclosure, the external map information EMI, the abnormal-time handling information AHI, and the like. Note that the CPU 1100 reads the program data 1450 from the HDD 1400 and executes the program data 1450. As another example, these programs may be acquired from another device via the external network 1550.

### 8. Effects

The moving body MB includes the space recognition processor VP and the operation controller FC. The space recognition processor VP generates the SLAM self-position information SPI that is the odometry information of the moving body MB and the map information MI. The operation controller FC generates the position and orientation information PI of the moving body MB based on the SLAM self-position information SPI. At an abnormal time when an abnormality occurs in the moving body MB, the operation controller FC causes the moving body MB to autonomously move based on the position and orientation information PI. At the normal time when the moving body MB operates normally, the operation controller FC controls the operation of the moving body MB according to the control instruction generated by the application processor AP based on the position and orientation information PI and the map information MI. In the information processing method of the present embodiment, the computer 1000 executes the processes of the moving body MB described above. The program (program data 1450) of the present embodiment causes the computer 1000 to implement the processes of the moving body MB described above.

According to this configuration, the behavior control at the abnormal time, using the position and orientation information PI, can be performed by the operation controller FC alone. Since the autonomous movement is possible even when the abnormality occurs in the moving body MB, robustness of the behavior control is enhanced. In addition, since the position and orientation information PI is generated by the operation controller FC, the processing load of the application processor AP is reduced. As a result, an abnormality such as a failure hardly occurs in the application processor AP.

The abnormality of the moving body MB is an abnormality of the application processor AP.

According to this configuration, robustness of the behavior control of the moving body MB when an abnormality occurs in the application processor AP is enhanced.

The space recognition processor VP selectively supplies the map information MI to the application processor AP, and selectively supplies the SLAM self-position information SPI to the operation controller FC. The application processor AP acquires the position and orientation information PI generated by the operation controller FC based on the SLAM self-position information SPI from the operation controller FC.

According to this configuration, the SLAM self-position information SPI and the map information MI are distributed and supplied to the operation controller FC and the application processor AP. Therefore, even when an abnormality occurs in the application processor AP, the operation controller FC can reliably generate the position and orientation information PI based on the SLAM self-position information SPI supplied from the space recognition processor VP. At the normal time, since the application processor AP can acquire the position and orientation information PI from the operation controller FC, the application processor AP can output the control instruction to the operation controller FC based on the acquired position and orientation information PI.

The application processor AP includes the behavior planning unit 21 and the first control instruction unit 23. The behavior planning unit 21 generates the behavior plan of the moving body MB based on the position and orientation information PI and the map information MI. The first control instruction unit 23 outputs the control target CT, as the control instruction, of the moving body MB conforming to the behavior plan to the operation controller FC.

According to this configuration, it is possible to generate a global behavior plan of the moving body MB based on the position and orientation information PI and the map information MI at the normal time.

The operation controller FC includes the second control instruction unit 33. The second control instruction unit 33 generates an abnormal-time behavior plan at the abnormal time. The second control instruction unit 33 generates the control target CT of the moving body MB conforming to the abnormal-time behavior plan based on the position and orientation information PI and the abnormal-time behavior plan.

According to this configuration, at the abnormal time, the moving body MB can be caused to perform an autonomous operation necessary for ensuring safety based on the abnormal-time behavior plan.

When a state in which no HeartBeat can be received from the application processor AP continues for a certain period of time or more, the operation controller FC determines that an abnormality has occurred in the application processor AP, and causes the moving body MB to autonomously move based on the position and orientation information PI.

According to this configuration, the abnormality of the application processor AP is easily determined.

As the autonomous operation at the abnormal time, the operation controller FC causes the moving body MB to perform hovering for a predetermined period from the occurrence of the abnormality. When the abnormality continues after the predetermined period, the operation controller FC causes the moving body MB to perform the return-to-home operation.

According to this configuration, even when an abnormality occurs, the moving body MB can safely return without falling based on the highly accurate position and orientation information PI.

The operation controller FC causes the moving body MB to start the return-to-home operation after elevating the moving body MB to a preset altitude.

According to this configuration, the risk that the moving body MB collides with the obstacle OT or the like is reduced.

Note that the effects described in the present specification are merely examples and not limited, and other effects may be provided.

### Supplementary note

The present technology can also have the following configurations.

(1)

A moving body comprising:
a space recognition processor configured to generate odometry information and map information of the moving body; and
an operation controller configured to generate position and orientation information of the moving body based on the odometry information, cause the moving body to perform autonomous movement based on the position and orientation information at an abnormal time when an abnormality occurs in the moving body, and control an operation of the moving body according to a control instruction generated by an application processor based on the position and orientation information and the map information at a normal time when the moving body operates normally.
   (2)

The moving body according to (1), wherein
the abnormality of the moving body is an abnormality of the application processor.
   (3)

The moving body according to (2), wherein
the space recognition processor selectively supplies the map information to the application processor, and selectively supplies the odometry information to the operation controller, and
the application processor acquires the position and orientation information generated by the operation controller, based on the odometry information, from the operation controller.
   (4)

The moving body according to (2) or (3), wherein
the application processor includes a behavior planning unit that generates a behavior plan of the moving body based on the position and orientation information and the map information, and a first control instruction unit that outputs a control target, as the control instruction, of the moving body to the operation controller, the control target conforming to the behavior plan.
   (5)

The moving body according to (4), wherein
the operation controller includes a second control instruction unit that generates an abnormal-time behavior plan at the abnormal time, and generates a control target of the moving body based on the position and orientation information and the abnormal-time behavior plan, the control target conforming to the abnormal-time behavior plan.
   (6)

The moving body according to any one of (2) to (5), wherein
the operation controller determines that the abnormality has occurred and causes the moving body to autonomously move based on the position and orientation information when a state in which no HeartBeat can be received from the application processor continues for a certain period of time or more.
   (7)

The moving body according to any one of (2) to (6), comprising
a wireless communication unit configured to perform wireless communication with the application processor mounted on a server.
   (8)

The moving body according to any one of (2) to (7), wherein
the operation controller causes the moving body to perform hovering, as the autonomous operation at the abnormal time, for a predetermined period from occurrence of the abnormality, and causes the moving body to perform a return-to-home operation when the abnormality continues after the predetermined period.
   (9)

The moving body according to (8), wherein
the operation controller causes the moving body to start the return-to-home operation after elevating the moving body to a preset altitude.
   (10)

An information processing method executed by a computer, the method comprising:
generating odometry information and map information of a moving body;
generating position and orientation information of the moving body based on the odometry information;
causing the moving body to autonomously move based on the position and orientation information at an abnormal time when an abnormality occurs in the moving body; and
controlling an operation of the moving body according to a control instruction generated by an application processor based on the position and orientation information and the map information at a normal time when the moving body operates normally.
   (11)

A program causing a computer to implement:
generating odometry information and map information of a moving body;
generating position and orientation information of the moving body based on the odometry information;
causing the moving body to autonomously move based on the position and orientation information at an abnormal time when an abnormality occurs in the moving body; and
controlling an operation of the moving body according to a control instruction generated by an application processor based on the position and orientation information and the map information at a normal time when the moving body operates normally.

### REFERENCE SIGNS LIST

21 BEHAVIOR PLANNING UNIT
23 FIRST CONTROL INSTRUCTION UNIT
33 SECOND CONTROL INSTRUCTION UNIT
AP APPLICATION PROCESSOR
FC OPERATION CONTROLLER
MB MOVING BODY
MI MAP INFORMATION
PI POSITION AND ORIENTATION INFORMATION
SPI SLAM SELF-POSITION INFORMATION (ODOMETRY INFORMATION)
SV SERVER
VP SPACE RECOGNITION PROCESSOR
WCU WIRELESS COMMUNICATION UNIT

1. A moving body comprising:
a space recognition processor configured to generate odometry information and map information of the moving body; and
an operation controller configured to generate position and orientation information of the moving body based on the odometry information, cause the moving body to perform autonomous movement based on the position and orientation information at an abnormal time when an abnormality occurs in the moving body, and control an operation of the moving body according to a control instruction generated by an application processor based on the position and orientation information and the map information at a normal time when the moving body operates normally.

2. The moving body according to claim 1, wherein
the abnormality of the moving body is an abnormality of the application processor.

3. The moving body according to claim 2, wherein
the space recognition processor selectively supplies the map information to the application processor, and selectively supplies the odometry information to the operation controller, and
the application processor acquires the position and orientation information generated by the operation controller, based on the odometry information, from the operation controller.

4. The moving body according to claim 2, wherein
the application processor includes a behavior planning unit that generates a behavior plan of the moving body based on the position and orientation information and the map information, and a first control instruction unit that outputs a control target, as the control instruction, of the moving body to the operation controller, the control target conforming to the behavior plan.

5. The moving body according to claim 4, wherein
the operation controller includes a second control instruction unit that generates an abnormal-time behavior plan at the abnormal time, and generates a control target of the moving body based on the position and orientation information and the abnormal-time behavior plan, the control target conforming to the abnormal-time behavior plan.

6. The moving body according to claim 2, wherein
the operation controller determines that the abnormality has occurred and causes the moving body to autonomously move based on the position and orientation information when a state in which no HeartBeat can be received from the application processor continues for a certain period of time or more.

7. The moving body according to claim 2, comprising
a wireless communication unit configured to perform wireless communication with the application processor mounted on a server.

8. The moving body according to claim 2, wherein
the operation controller causes the moving body to perform hovering, as the autonomous operation at the abnormal time, for a predetermined period from occurrence of the abnormality, and causes the moving body to perform a return-to-home operation when the abnormality continues after the predetermined period.

9. The moving body according to claim 8, wherein
the operation controller causes the moving body to start the return-to-home operation after elevating the moving body to a preset altitude.

10. An information processing method executed by a computer, the method comprising:
generating odometry information and map information of a moving body;
generating position and orientation information of the moving body based on the odometry information;
causing the moving body to autonomously move based on the position and orientation information at an abnormal time when an abnormality occurs in the moving body; and
controlling an operation of the moving body according to a control instruction generated by an application processor based on the position and orientation information and the map information at a normal time when the moving body operates normally.

11. A program causing a computer to implement:
generating odometry information and map information of a moving body;
generating position and orientation information of the moving body based on the odometry information;
causing the moving body to autonomously move based on the position and orientation information at an abnormal time when an abnormality occurs in the moving body; and
controlling an operation of the moving body according to a control instruction generated by an application processor based on the position and orientation information and the map information at a normal time when the moving body operates normally.
